(19) United States
(12) Patent Application Publication
(10) Pub. No.: US 2026/0251293 A1
(43) Pub. Date: Aug. 27, 2026

(54) SELF-CONTAINED, WIRELESS WINDOW SYSTEM WITH VISIBLY TRANSPARENT ELECTRICITY-GENERATING GLASS AND ENERGY STORAGE

(71) Applicant: Andluca Technologies Inc., Rochester, NY (US)

(72) Inventors: Nicholas C. Davy, Houston, TX (US); Adrian Winoto, San Francisco, CA (US); Thomas Schumann, Carson City, NV (US); Ismet Tudjinovic, Alameda, CA (US)

(21) Appl. No.: 19/548,821

(22) Filed: Feb. 24, 2026

Related U.S. Application Data
(60) Provisional application No. 63/762,394, filed on Feb. 24, 2025.

(51) Int. Cl. F21V 33/00; E06B 7/28; E06B 9/24; F21S 9/03; F21Y 115/10

(52) U.S. Cl. CPC F21V 33/006; E06B 7/28; F21S 9/03; E06B 9/24; E06B 2009/2464; E06B 2009/2476; F21Y 2115/10

(57) ABSTRACT

A self-contained, wireless window system integrates lighting natively within the window frame, sash, or glazing bead while maintaining full architectural transparency. The window incorporates visibly transparent electricity-generating glass, such as transparent photovoltaic or luminescent solar concentrator glass, which harvests renewable energy during daylight hours. Harvested energy is stored in an internal energy storage element and used to power integrated lighting elements without external wiring or manual recharging. Window-native lighting may provide safety lighting, ambient lighting, tunable or multicolored illumination, and adaptive smart lighting functions. The system positions the window as a central platform for managing natural and artificial light, solar heat gain, glare, privacy, and security. Integrated power management coordinates energy harvesting, storage, and deployment to enable sustainable operation. Lighting and other applications may be controlled via local hardware, smartphone applications, cloud-based systems, or AI-driven adaptive control, delivering a curated interior lighting and comfort experience.

### PRIORITY

This patent application claims priority from U.S. Provisional Application No. 63/762,394, filed Feb. 24, 2025, entitled, “WINDOW-NATIVE LIGHTING POD WITH SOLAR-HARVESTING GLASS AND ENERGY STORAGE,” and naming Nicholas C. Davy, Adrian Winoto, Thomas Schumann, and Ismet Tudjinovic as inventors, the disclosure of which is incorporated herein, in its entirety, by reference.

### FIELD

Illustrative embodiments of the invention generally relate to self-powered windows and, more particularly, various embodiments of the invention relate to smart, self-powered windows incorporating lighting “natively” into the window frame, and various components and battery storage.

### BACKGROUND

There is interest in increasing the functionality of windows. For instance, in addition to providing a transparent barrier between the interior and exterior of a structure, designers have conceived of windows that provide improved thermal insulation, automatically changeable color tints, electrochromic functionality, and the like. Some of the desired functions to include with modern windows include electrical components. Since those electrical components require electrical power, a source of power must be connected to the windows to enable operation. Incorporation of lighting into the window frame would be interesting.

### SUMMARY OF VARIOUS EMBODIMENTS

In accordance with one embodiment of the invention, a powered window system includes a window assembly comprising a frame and an integrated glass unit (IGU), visibly transparent electricity-generating glass forming at least a portion of the IGU, at least one energy storage device electrically coupled to the visibly transparent electricity-generating glass, at least one electronic pod integrated into the window assembly, and a power management system.

The at least one electronic pod is configured to receive electrical power generated by the visibly transparent electricity-generating glass and to operate without external wiring to the window assembly. The power management system controls energy harvesting, storage, and deployment to optimize efficiency and operating modes.

The at least one electronic pod may be integrated into a glazing bead or frame channel of the window assembly, and the at least one electronic pod may include a lighting element.

Electrical power may be routed internally within the window assembly from the visibly transparent electricity-generating glass to the at least one electronic pod. The at least one electronic pod may be installable and removable from the window assembly.

The energy storage device may be located within the at least one electronic pod. The energy storage device may be located within a glazing bead or frame element of the window assembly.

The lighting element may include one or more light-emitting diodes and a diffuser. The lighting element may be configured to provide ambient lighting, task lighting, safety lighting, or accent lighting.

The at least one electronic pod may include a communication module that can be configured to communicate wirelessly using a smart-home protocol, and the smart-home protocol may include Matter, Zigbee, Z-Wave, Bluetooth, Wi-Fi, or RF communication.

The visibly transparent electricity-generating glass may include transparent photovoltaic material, ultraviolet light-converting material, or luminescent solar concentrator material.

In accordance with another embodiment of the invention, a modular electronic pod for installation in a window assembly includes a housing dimensioned to fit within a glazing bead or frame channel of a window, at least one electronic component, and an electrical interface configured to receive power from visibly transparent electricity-generating glass within the window assembly. The pod is installable and removable within the window assembly.

The electronic component may include a lighting element. The electronic component may include at least one of a sensor, camera, motor, or communication module.

The electronic pod may further include an energy storage device. The pod may be installable from an interior side of the window assembly.

In accordance with another embodiment of the invention, a method of powering window-integrated functions includes generating electrical power using visibly transparent electricity-generating integrated glass unit (IGU) within a window assembly, storing the generated electrical power within the window assembly, and operating an electronic pod integrated into the window assembly using the stored electrical power. The electronic pod operates without external wiring to the window.

The operation of the electronic pod may be to illuminate an interior space. The electronic pod may be installed or replaced without removing the window assembly.

In accordance with another embodiment of the invention, a window assembly includes an insulated glass unit (IGU) including visibly transparent electrical-power generating glass, internal electrical conductors extending along an edge of the insulated glass unit, and one or more window-integrated functions integrated into the window assembly. The one or more window-integrated functions are powered by electrical power generated by the IGU, and the electrical power is conducted to the one or more window-integrated functions via the internal electrical conductors.

The window assembly may further include a frame, and the frame may be configured to secure the IGU.

The window assembly may further include at least one electronic pod integrated into the window assembly. The one or more window-integrated functions may be positioned in the at least one electronic pod.

The window assembly may further include a power management system. The electronic pod may be configured to receive electrical power generated by the electrical-power generating glass and to operate without external wiring to the window assembly. The power management system may control energy harvesting, storage, and deployment to optimize efficiency and operating modes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1A schematically shows a drawing of an embodiment of the wireless window system according to an embodiment of the invention.

FIG. 1B shows an expanded illustration of a low power charging pod according to an embodiment of the invention.

FIG. 2 illustrates an embodiment of a lighting element according to an embodiment of the invention.

FIG. 3A shows a non-limiting embodiment of a smart-home control device according to an embodiment of the invention.

FIG. 3B shows another non-limiting embodiment of a smart-home control device according to an embodiment of the invention.

FIG. 4 illustrates an embodiment of a smart window assembly incorporating a window-native lighting pod according to an embodiment of the invention.

FIG. 5 shows a schematic illustration of a power management system pod according to an embodiment of the invention.

FIG. 6A shows a window assembly with a motorized smart shade in a raised position according to an embodiment of the invention.

FIG. 6B shows a window assembly with the motorized smart shade in a lowered position according to an embodiment of the invention.

FIG. 7A shows a window-integrated security pod incorporated into a powered window assembly according to an embodiment of the invention.

FIG. 7B shows a window-integrated security pod incorporated into a powered window assembly that includes a dynamic tint or smart-glass according to an embodiment of the invention.

FIG. 8A shows a portion of a combined security-privacy pod according to an embodiment of the invention.

FIG. 8B shows a portion of a combined security-privacy pod installed within a glazing bead of a window frame according to an embodiment of the invention.

FIG. 9 shows a smart window assembly incorporating modular, insertable components according to an embodiment of the invention.

FIG. 10 shows an insulated glass unit configured as a visibly transparent electricity-generating glass unit incorporating internal electrical routing according to an embodiment of the invention.

FIG. 11 shows a face-on view of an integrated window system in its fully assembled configuration according to an embodiment of the invention.

FIG. 12 shows a three-quarter view of an integrated window system in its fully assembled configuration according to an embodiment of the invention.

FIG. 13 shows another self-contained, wireless window system according to an embodiment of the invention.

FIG. 14 shows a schematic representation of an embodiment of solar-generating glass units according to an embodiment of the invention.

FIG. 15 shows a schematic illustration of a laminated insulated glass unit according to an embodiment of the invention.

FIG. 16 schematically shows an embodiment of a transparent luminescent solar concentrator according to an embodiment of the invention.

FIG. 17 shows a method of powering window-integrated functions according to an embodiment of the invention.

### DESCRIPTION OF ILLUSTRATIVE EMBODIMENTS

In illustrative embodiments, a self-contained, wireless window system integrates lighting “natively” into the window frame, sash, or glazing bead while remaining a transparent architectural element capable of providing illumination during both daytime and nighttime. In some embodiments, the window itself serves as the power source for the integrated lighting, leveraging transparent or semi-transparent electricity-generating glass, such as transparent photovoltaic glass, a luminescent solar concentrator (e.g., Innovio glass), or other photovoltaic elements, to harvest renewable energy during daylight hours. The harvested energy is stored in an internal energy storage element (e.g., battery, capacitor, and/or hybrid storage device) and later used to power one or more window-native lighting elements without the need for external wiring or manual recharging. This eliminates in-home wiring associated with lighting fixtures and reduces installation complexity in new construction, remodeling, or retrofit scenarios.

“Window-native” typically refers to a component, system, or functionality that is integrated with a window assembly such that the window assembly itself provides structural support and/or housing for the component. A window-native component may be installed during manufacture, during window installation, or after installation, and may occupy space within the frame, glazing bead, insulated glass unit, or other portion of the window assembly. In some embodiments, window-native components are configured to operate while substantially maintaining the external appearance and installation envelope of an architectural window.

“IGU” typically refers to an insulated glass unit that includes the incorporation of multiple functional coatings and interlayers within an insulated glazing structure glass layer. An IGU typically includes an outer layer and an inner layer separated by solar energy-generating functional interlayer. An IGU may also include one or more layers of dynamic glass.

For example, a night-light pod integrated into the window frame may draw stored energy collected during the day from the glass itself and deliver illumination at night for purposes such as safety lighting, nursery lighting, warm ambient lighting, biophilic lighting, or smart adaptive lighting. “Pod” typically refers to a discrete, self-contained module or unit that houses one or more functional components and is configured to be integrated into a window assembly. A pod may include electronic, electrical, mechanical, optical, or electromechanical components, such as lighting elements, sensors, cameras, motors, processors, communication modules, control circuitry, or combinations thereof. A pod may be dimensioned to fit within, attach to, or replace a portion of a window frame, glazing bead, or frame channel, and may be installable and removable to facilitate maintenance, replacement, or upgrade without removal of the window assembly.

“Glazing bead” typically refers to a retention member configured to retain, secure, position, or support an IGU relative to a window frame. A glazing bead may extend along one or more edges of the IGU and may be located on an interior side, an exterior side, or between components of the window assembly. The glazing bead may be a separate component or may be integrally formed with the window frame, and may be removable or fixed. In some embodiments, a glazing bead also functions as a housing or support structure for one or more pods and/or other components.

In some embodiments, multicolored or tunable lighting may be provided to support personalization and aesthetic interior design preferences, while in other embodiments, the emphasis may be on low-power safety illumination or subtle nighttime ambiance. The lighting system maximizes illumination efficiency while minimizing energy consumption so that it may be powered by the window's integrated solar generation and associated energy storage. In many implementations, the system operates independently of continuous external electrical infrastructure.

Various embodiments represent a combination architecture in which the window, power harvesting, energy storage, power management, and lighting application operate as a unified platform. Physical prototypes have demonstrated reduction to practice of this integrated wireless window-lighting concept. Commercially, the system positions the window as a central anchor of the interior lighting environment, coordinating natural light, artificial light, solar heat gain control, glare mitigation, privacy control, and security functions. Window-native lighting may operate cooperatively with dynamic glass tinting, motorized shading systems, room-based lighting fixtures, and environmental sensors.

Control of the system may be manual or automated and may include smartphone applications, voice assistants, local hardware controllers, cloud-based management, or AI-driven adaptive learning systems. In such embodiments, artificial lighting integrated within the window can coordinate with dynamic control of natural daylight transmission to deliver a curated lighting and comfort experience tailored to user behavior, time of day, climate conditions, and energy availability. The result is a self-contained, wire-free smart window platform that delivers comfort, safety, ambiance, and energy efficiency while preserving architectural aesthetics.

Various embodiments described herein provide significant advantages over conventional windows and existing smart-window solutions. By generating electrical power directly within the window assembly using visibly transparent electricity-generating glass and distributing that power internally within the window assembly, the system eliminates the need for external wiring, wall penetrations, or connection to building electrical infrastructure. As a result, the window assemblies may be installed in substantially the same manner as standard, unpowered windows, without additional installation steps, specialized labor, or electrical permitting. Further, the use of modular, window-native electronic pods enables the system to be upgradeable and reconfigurable over time, allowing electronic components to be installed, replaced, or removed without removing the window or disturbing the surrounding structure. This modular architecture supports a wide range of window-integrated functions, including lighting, security, privacy, shading, sensing, and smart-home connectivity while preserving the appearance, simplicity, and installability of a conventional window. The combination of self-generated power, internal energy storage, and interchangeable pods enables a flexible, future-proof window platform capable of evolving alongside emerging smart-home technologies.

As used herein, the terms “solar-generating glass,” “solar-harvesting glass,” “electricity-generating glass,” and “power-generating glass” refer to visibly transparent glass configured to convert incident light into electrical energy, and are used interchangeably.

In various embodiments, the powered window system includes one or more lighting pods integrated directly into the window assembly, such as by forming or replacing a glazing bead or occupying a channel within the window frame. Each lighting pod may contain one or more light-emitting elements, associated drive electronics, and optical components such as diffusers, and is electrically coupled to visibly transparent solar-harvesting glass within the IGU. Electrical power generated by the solar-harvesting glass may be stored in one or more internal energy storage devices, such as batteries or capacitors located within the pod, within a glazing bead, or within another portion of the window frame, enabling operation during periods of low or no sunlight.

In various embodiments, the lighting pods are installable and removable, allowing for maintenance, repair, or replacement without removing the window assembly or disconnecting external wiring. In some embodiments, the lighting pods further include wireless communication circuitry, including communication modules, enabling integration with smart-home systems, such that illumination may be controlled via smartphones, voice assistants, or automated control systems using one or more wireless communication protocols.

In some embodiments, a self-contained, self-powered window system includes functional lighting and other electronic features which are integrated directly into the window assembly rather than added as external accessories. The window system may include solar power-generating glass, such as visibly transparent photovoltaic glass or ultraviolet light-converting glass, which generates electrical energy in response to incident light while maintaining transparency suitable for architectural use. Electrical power generated by the solar-generating glass is conveyed through internal electrical circuits and conductors disposed along edges of an insulated glass unit, within glazing beads, or within structural members of the window frame, such that electrical distribution remains concealed and protected within the window assembly.

The window assembly may further include one or more pods that house electronic components and are structurally integrated into the window, for example by forming, replacing, or occupying glazing beads or frame channels. The pods may contain lighting components, such as one or more light-emitting diodes and associated drive electronics, as well as additional components including control circuitry, sensors, communication modules, motors, or processors. The pods are electrically coupled to the internal electrical circuits and receive power generated by the solar-generating glass.

In addition, the window system may include one or more energy storage devices, such as rechargeable batteries or capacitors, positioned within the pods, within glazing beads, or elsewhere in the window frame. The energy storage devices store electrical energy generated by the solar-generating glass and supply power to the pods during periods of low illumination or darkness. The internal electrical circuits are configured to distribute electrical power between the solar-generating glass, the energy storage devices, and the pods, and may include power management circuitry for regulating voltage, charging the energy storage devices, and selectively supplying power to different components.

Through this integrated architecture, the window system may operate as a self-contained unit in which power generation, storage, and consumption occur entirely within the window assembly, eliminating the need for external wiring, electrical outlets, or building power connections. The result is a window that installs and functions as a conventional architectural window while simultaneously providing built-in lighting and other electronic functionality in a modular, scalable, and energy-efficient manner.

The self-contained window system may be secured to or integrated with a structural element of a window, such as a window frame, a glazing bead, or a similar retention or support component. As used herein, a “glazing bead” refers to a strip, molding, or structural member that is configured to retain, secure, or position an IGU within a window frame, and may be located on an interior side, an exterior side, or between components of the window assembly. The glazing bead may be formed as a separate component or integrally with the window frame, and may extend along one or more edges of the IGU. In some embodiments, the self-contained window system, including one or more pods or electronic components, is secured to, housed within, or replaces a glazing bead such that the system performs both a glazing retention function and an electronic component housing function. In this manner, functional electronic elements may be incorporated into the window assembly without increasing the external dimensions of the window or altering conventional installation practices.

The solar-generating window may also be referred to as an insulated glass unit (IGU), which generally includes two or more glass layers separated by one or more spacers to form an insulating cavity. In some embodiments, the IGU incorporates visibly transparent electricity-generating glass in at least one of the glass layers, enabling the IGU to generate electrical power while maintaining transparency suitable for architectural applications. In further embodiments, one or more glass layers of the IGU include electrochromic layers or coatings that are selectively controllable to vary optical properties of the window, such as visible light transmission, glare reduction, or solar heat gain. The electrochromic layers may provide dimming and/or tinting functionality, allowing the window system to transition between transparent, partially tinted, and darkened states in response to user input, environmental conditions, or automated control signals. Electrical power generated by the solar-generating glass may be used to operate the electrochromic layers, may be stored in one or more internal energy storage devices, or may be distributed to other components of the window system, such that the IGU functions as an integrated platform for power generation, energy management, and controllable optical performance.

The solar-generating window may utilize photovoltaic (PV) materials and devices configured to convert incident light into electrical energy while remaining suitable for use in architectural glazing. The photovoltaic materials may be visibly transparent, semi-transparent, or selectively transmissive, such that a portion of visible light passes through the window while another portion is converted into electrical power. In some embodiments, photovoltaic materials may include, without limitation, thin-film photovoltaic materials, organic photovoltaic materials, perovskite-based materials, dye-sensitized photovoltaic materials, quantum-dot-based photovoltaic materials, or combinations thereof. In some embodiments, the photovoltaic materials are deposited as coatings or layers on one or more glass panes of an insulated glass unit, embedded within laminated glass, or otherwise integrated into the glazing structure.

The photovoltaic devices may be electrically interconnected to form one or more power-generating regions within the window and may be arranged to balance electrical output, optical transparency, and aesthetic appearance. Electrical energy generated by the combination of photovoltaic materials and any associated energy conversion components may be supplied directly to internal electrical circuits, stored in one or more energy storage devices, or used to power integrated electronic components of the window system, including lighting pods, control electronics, and smart-home interfaces.

In various embodiments, the self-contained, wireless window system includes an integrated power management system that is defined by a structured system-level framework comprising three primary functional blocks: a power source, energy management and storage, an application layer. In some embodiments, the wireless window system also includes a power management control unit as a sub-block. The power source is implemented within the window glass itself, such as electricity-generating glass that harvests ambient light and converts it into electrical energy. The harvested energy is delivered to an energy management and storage module that performs voltage regulation, charge control, conditioning, and storage in one or more energy storage elements (e.g., batteries or capacitors). Stored energy is then supplied to one or more application modules, which may include lighting, motorized shading, privacy systems, motion sensing, security cameras, or other window-integrated functions. The optional power management control unit (“brain”) may coordinate the functions of energy harvesting, storage, and distribution based on operating conditions and system demands. In some embodiments, the functions of the power management control unit are distributed throughout the wireless window system. While these functional blocks are conceptually distinct to clarify operation, their physical implementation may be integrated within the IGU or distributed across the window frame or glazing bead, providing architectural flexibility while preserving system coherence.

“Visibly transparent electricity-generating glass” typically refers to glazing material configured to generate electrical energy from incident electromagnetic radiation while transmitting at least a portion of visible light. The electricity-generating functionality may be provided by one or more photovoltaic or other light-to-electricity conversion structures, including coatings, films, laminated layers, embedded devices, or combinations thereof, and may be integrated into one or more panes of an insulated glass unit

### Window-Native Lighting Pods

Light engineering considerations focus on delivering effective interior illumination within the constraints of a self-powered window system. Embodiments may utilize LED strips combined with optical diffusers to convert discrete point sources into uniform, visually comfortable light output. Alternatively, light guides employing total internal reflection may distribute light from one or more localized LEDs along extended window regions, enabling broader illumination with fewer active sources. These optical strategies are selected to minimize electrical power consumption while maximizing perceived illumination, thereby supporting operation from energy harvested and stored within the window system. The lighting design is engineered to function within sustainable daily recharge cycles, such that energy captured by the solar-harvesting glass during daylight hours is sufficient to power nighttime or low-light applications.

In various embodiments, whether using LEDs with diffusers or point source LEDs with light guides, the integrated combination of solar-harvesting glass, internal energy storage, and efficient optical light delivery within a wire-free, window-native platform is optimized for efficient conversion of available solar energy into a predetermined lighting environment.

In some embodiments, the window-native lighting pods comprise one or more LED lighting elements configured to emit light into an interior space adjacent the window. The LED lighting elements may include linear LED strips, discrete LEDs, or LED arrays, and may be selected to provide desired color temperature, brightness, and energy efficiency characteristics. The lighting pods may further include one or more diffusers, lenses, or optical elements positioned to distribute light evenly, reduce glare, and convert point-source illumination into a continuous or uniform light output. The lighting pods may also include a single LED point light source that is wave-guided along a length of a glazing bead or a pod housing.

The lighting elements and diffusers are housed within a pod housing that is dimensioned and shaped to fit within a glazing bead, frame channel, or similar structural feature of the window assembly. The pod housing may be elongated, segmented, or otherwise configured to extend along a portion of the perimeter of the IGU, such as along a top edge, bottom edge, or side edge of the window. In some embodiments, the pod housing performs both a structural function, such as retaining or supporting the IGU, and an electronic function, such as enclosing lighting and control components.

The window-native lighting pods are preferably installable and removable within the window assembly, allowing the pods to be installed, removed, replaced, or upgraded without removing the window from a structure or disturbing surrounding building materials. In various embodiments, the pods are slide-in components that are inserted into a glazing bead channel or frame recess, snap-fit components that engage corresponding retention features of the window frame or glazing bead, or components that are retained by the geometry of the glazing bead itself once the IGU is secured.

The lighting pods may be accessible from an interior side of the window, enabling service or replacement from within a building without exterior access equipment. Electrical coupling between the lighting pod and internal power circuits of the window assembly may be achieved automatically upon installation, such as through conductive contacts, spring terminals, or other mating electrical interfaces, thereby eliminating the need for manual wiring connections.

The window-native lighting pods may be configured to operate in one or more lighting modes, depending on user preferences, environmental conditions, or automated control settings. In some embodiments, the pods provide ambient lighting to softly illuminate an interior space near the window. In other embodiments, the pods provide task lighting, such as focused illumination for reading, working, or other activities performed adjacent the window.

The lighting pods may additionally or alternatively provide night-light illumination, delivering low-level light suitable for nighttime navigation, or safety or pathway illumination, such as illuminating a walking path, stairway, or exit route near the window. In further embodiments, the pods provide accent lighting to highlight architectural features, window geometry, or interior design elements. Lighting modes may be selectable manually, via smart-home controls, or automatically in response to time of day, occupancy, or ambient light conditions.

### Modular Pod Ecosystem

In some embodiments, the window system implements a modular pod ecosystem in which multiple types of pods share a common mechanical, electrical, and functional interface within the window assembly. The pods are interchangeable and upgradable, allowing different pod types to be installed, removed, or replaced without modifying the window frame, IGU, or internal electrical infrastructure. This modular architecture enables a single window platform to support evolving functionality over time, including the addition of new capabilities as pod technologies advance.

The pods may be configured to connect to standardized mechanical retention features and electrical interfaces within the window assembly, such that each pod automatically receives power and communicates with other system components upon installation. Pods may be installed individually or in combination, and multiple pods of the same or different types may be distributed along different portions of the window, such as along top, bottom, or side glazing beads.

In some embodiments, pods include, without limitation, a lighting pod configured to provide interior illumination adjacent the window; a security pod comprising one or more security-related components such as a camera, motion sensor, impact sensor, or lock or unlock sensor; a privacy pod configured to provide visual privacy, such as by controlling electrochromic glass, deploying a privacy screen, or selectively obscuring a portion of the window; a smart shade motor pod configured to drive a motorized shade, blind, or curtain integrated with the window; and an environmental sensor pod configured to sense environmental conditions such as ambient light, temperature, humidity, air quality, vibration, or occupancy. Each pod type may operate independently or cooperatively with other pods and may be controlled locally or via a smart-home system.

Through this modular pod ecosystem, the window system provides a scalable and future-proof architecture in which functionality can be customized for different applications, user preferences, or building requirements, while maintaining a common window structure and eliminating the need for external wiring or auxiliary devices.

### Smart-Home Integration

In some embodiments, the window system and one or more pods integrated therein are configured for smart-home integration via wireless communication, enabling remote monitoring, control, and automation of window-native functions. Each pod, or a shared control module within the window assembly, may include wireless communication circuitry and/or communication modules that supports one or more wireless communication protocols. In various embodiments, protocols include Matter, Zigbee, Z-Wave, Bluetooth, and Wi-Fi, although other present or future wireless protocols may also be used.

Through wireless connectivity, the window system may communicate with smart-home hubs, gateways, or cloud-based services, allowing users to control lighting, shading, privacy, security, or other pod functions using smartphone applications running on mobile computing devices. The smartphone applications may provide user interfaces for selecting operating modes, adjusting brightness or color temperature, scheduling operation, monitoring system status, or receiving notifications from sensors integrated into the window system.

In some embodiments, the window system is further configured to interface with voice-controlled digital assistants, enabling hands-free operation of window-native functions. Voice commands may be used to activate or deactivate lighting pods, adjust lighting levels, control smart shades, change privacy states, or query sensor data. The smart-home integration may also support automated control based on rules, schedules, or environmental inputs, such as time of day, ambient light levels, occupancy detection, or energy availability. In this manner, the window system operates as an intelligent, networked component of a broader smart-home or smart-building ecosystem.

### Installation and Retrofitting

The powered window system is configured to be installed in substantially the same manner as a conventional, unpowered window, without requiring specialized tools, electrical expertise, or modification to existing building electrical infrastructure. In some embodiments, the window assembly is mounted within a rough opening of a building structure using standard window installation techniques, such as fastening to framing members and sealing around a perimeter of the window, while the integrated electronic components remain fully contained within the window assembly.

The window system is suitable for new construction applications, where the powered window may be installed during initial building construction in place of a traditional window. The system is also suitable for retrofit installations, in which an existing window is removed and replaced with the powered window system without the need to run electrical wiring through walls, modify interior finishes, or connect to building power circuits. In further embodiments, the window system supports do-it-yourself (DIY) installation, enabling homeowners or non-specialist installers to install or replace the window using standard tools and procedures.

Because electrical power is generated by the window itself and distributed internally, no external wiring, electrical outlets, or hardwired connections are required to operate the integrated lighting and other pod functions. This self-contained power architecture reduces installation complexity, minimizes disruption to existing structures, and enables powered window functionality in locations where access to electrical wiring is limited or impractical.

### Alternative Embodiments and Variations

The embodiments described herein are intended to be illustrative rather than limiting, and numerous variations and modifications will be apparent to those skilled in the art. In alternative embodiments, one or more pods may be positioned at different locations within the window assembly, including along a top edge, bottom edge, or one or more side edges of the IGU or window frame. Pods may be arranged symmetrically or asymmetrically, and different pod types may be located at different positions based on functional requirements, aesthetic considerations, or installation constraints.

In some embodiments, a single window assembly includes multiple pods, which may be of the same type or of different types. For example, a window may include multiple lighting pods distributed along a perimeter of the window, or a combination of lighting, security, sensor, and shade motor pods operating together. Multiple pods may operate independently or in a coordinated manner, such as providing uniform illumination or shared sensing and control functionality.

The window system may also employ different glass chemistries and energy-harvesting technologies, depending on desired performance characteristics. For example, the electricity-generating glass may utilize transparent or semi-transparent photovoltaic materials, ultraviolet-converting materials, or combinations thereof, and may be integrated with electrochromic, thermochromic, photochromic, or other functional glass layers. The selection and arrangement of glass chemistries may be optimized for energy generation, optical clarity, thermal performance, or aesthetic appearance.

Energy storage within the window system may be implemented using distributed or centralized architectures. In distributed embodiments, each pod includes its own dedicated energy storage device, enabling localized power management and independent operation. In centralized embodiments, one or more energy storage devices are located within a common portion of the window assembly, such as within a frame element or glazing bead, and electrical power is distributed from the centralized storage device to multiple pods. Hybrid configurations combining distributed and centralized storage may also be employed. These alternative embodiments allow the window system to be tailored to different use cases, power requirements, and manufacturing considerations.

### Embodiments of Use Cases

The powered window systems described herein may be deployed in a wide range of residential, commercial, and institutional environments, providing integrated functionality without requiring external power connections or structural modifications. In residential smart-home applications, the window system may be used to provide window-integrated lighting, smart shading, privacy control, environmental sensing, and security monitoring, all of which may be controlled through smartphone applications or voice assistants. The modular pod architecture allows homeowners to customize window functionality on a room-by-room basis and to upgrade or add features over time as needs evolve.

In commercial building applications, including offices, retail spaces, hospitality environments, and multi-unit residential buildings, the window system may provide scalable, low-maintenance lighting and smart-building functionality. For example, window-integrated lighting pods may supplement ambient lighting near exterior walls, reduce reliance on overhead fixtures, and enhance occupant comfort. Integrated sensors and smart-home connectivity may support building automation, energy management, security monitoring, and compliance with building efficiency standards.

The window system may also be employed in safety and pathway lighting applications, such as illuminating walkways, stairwells, exits, or egress routes adjacent to windows. Because the system is self-powered and includes internal energy storage, lighting pods may continue to operate during power outages, providing emergency illumination without reliance on backup generators or external batteries.

In addition, the window system is well suited for energy-efficient renovations and retrofits, where minimizing disruption and avoiding new electrical wiring is desirable. Existing windows may be replaced with powered window systems to introduce lighting, sensing, or smart-home functionality while improving energy performance through advanced glazing and on-window energy generation. This enables building owners to enhance functionality and efficiency in older structures without extensive remodeling or electrical upgrades.

### Smart Homes With Window-Native Lighting

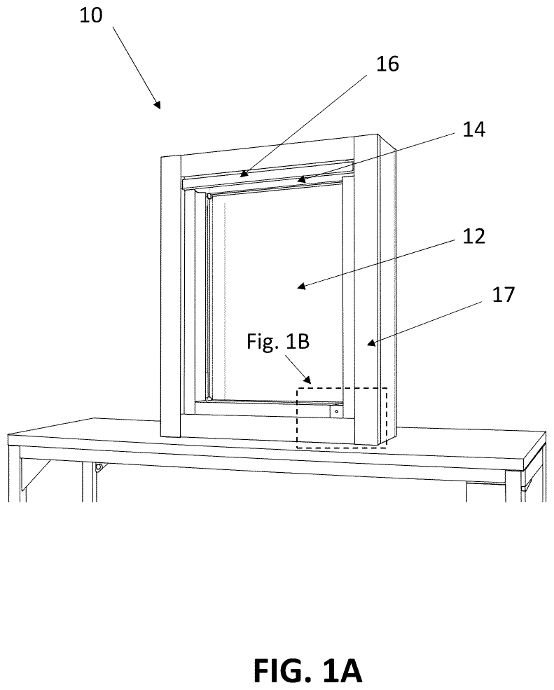

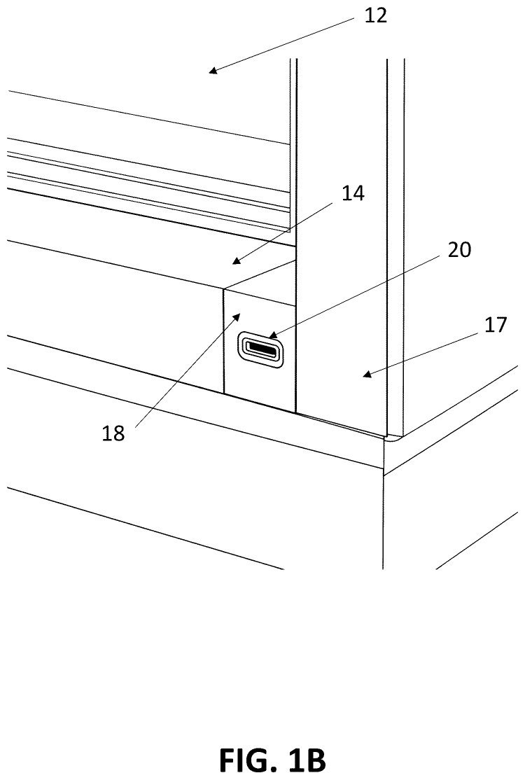

FIG. 1A shows a drawing of an embodiment of a self-contained, self-powered wireless window system that integrates lighting “natively” into the window frame, or sash while preserving the primary function of the window as a transparent architectural element capable of providing illumination during both daytime and nighttime conditions.

FIG. 1A shows a drawing of an embodiment of the self-powered smart window assembly 10 viewed from the inside of the window 10. The smart window assembly 10 includes solar-generating glass unit 12 mounted in the window assembly 10. The solar power generating glass unit 12 is transparent or semi-transparent to visible light, yet provides direct current (DC) current to window components. The solar-generating glass unit 12 absorbs ultraviolet (UV) radiation from the sunlight incident on the smart window assembly 10 and allows visible light to pass through the smart window assembly 10.

A glazing bead 14 surrounds the solar-generating glass unit 12 and holds the solar-generating glass 12 in place, as well as provide desired features, accessories, and/or applications. In some embodiments, the glazing beads are designed in horizontal orientations to position pods on the inside portion of the top, side, and bottom frame elements. For example, a non-limiting feature of a lighting pod 16 is powered by the visibly transparent electricity-generating glass unit in FIG. 1A. A frame 17 surrounds the glazing bead 14 and solar-generating glass unit 12 and it provides secure attachment to the structure.

The lighting pod 16 is powered by the visibly transparent electricity-generating glass unit 12, which forms at least a portion of the window's glazing. In the illustrated embodiment, the electricity-generating glass unit 12 is of the type manufactured by Andluca; however, the invention is not limited to any particular manufacturer or glass technology.

In this embodiment, the lighting pod 16 is mounted along an upper interior portion of the smart window assembly 10 and attaches as a custom glazing bead that replaces or supplements a conventional glazing bead. As shown, the glazing bead-mounted lighting pod 16 extends horizontally across the top edge of the IGU and is seated within a corresponding channel of the window frame 17. The integration of the lighting pod 16 as a glazing bead allows the lighting pod 16 to be structurally incorporated into the window assembly 10 while maintaining the appearance and installation profile of a standard window.

The lighting pod 16 includes an elongated light-emitting element configured to direct illumination downward into the interior space adjacent the window. The light-emitting element may include one or more light-emitting diodes (LEDs) and may further include a diffuser or optical covering that provides uniform illumination along the length of the pod. The pod housing is dimensioned and color-matched to the window frame, contributing to a visually seamless integration with the window assembly.

Although not visible in the drawing, the lighting pod 16 is electrically coupled to the visibly transparent electricity-generating glass unit 12 via internal electrical conductors routed within the window frame 17 and/or along an edge visibly transparent electricity-generating glass unit 12. Electrical energy generated by the visibly transparent electricity-generating glass unit 12 may be delivered directly to the lighting pod 16 and optionally stored in one or more energy storage devices located within the lighting pod 16, within the glazing bead 14, or elsewhere in the window assembly. As a result, the lighting pod 16 is capable of operating without external wiring connected to building electrical infrastructure.

In some embodiments, the lighting pod 16 is color-matched to the frame and turned “on” via a handheld remote. The interior of the frame may also include a bottom glazing bead with USB-C port for charging an external electronic device, such as a mobile phone, as indicated in the dashed box. In this embodiment, the USB-C charging port is powered by one or more batteries in the frame which can store energy produced by the visibly transparent electricity-generating glass unit 12. Importantly, the one or more batteries in the top, bottom, or side glazing beads can be recharged via the visibly-transparent electricity-generating glass unit. Both the bottom glazing bead and the top glazing bead are installable and removable “pods” that appear to be part of the fixed frame but are in fact easily removed or accessed for maintenance or battery replacement.

In some embodiments, the USB-C port is only an output port that derives its electrical energy output from the visibly transparent electricity-generating glass unit 12. However, in other embodiments, for applications, such as an existing privacy pod, a USB-C port may be an input-only port. In some embodiments, a USB-C port on an application pod may be either an input or an output port.

FIG. 1B shows an expanded illustration of a low power charging pod 18 with a power interface plugged into the charging (e.g., power) pod 18 in a USB-C plug 20. The solar-generating window unit 12 provides electrical power to the window assembly (e.g., system) 10. This illustrates a non-limiting embodiment of a power interface integrated into a glazing bead 14 of a window assembly 10, providing electrical access for a window-native electronic pod, such as a lighting pod 16. In the illustrated embodiment, the glazing bead 14 forms part of the interior-facing portion of the window frame 17 and is dimensioned to receive one or more electronic components while maintaining the structural and aesthetic characteristics of a conventional glazing bead.

As shown, the glazing bead 14 includes a power input port, illustrated as a USB-C connector 20, exposed on an interior-facing surface of the glazing bead. The power input port provides a physical electrical interface through which the lighting pod 16 and/or other window-integrated functions (e.g., electronic devices) may receive electrical power. While a USB-C connector 20 is shown, the power input port may alternatively comprise any suitable electrical charging or power transfer interface, including but not limited to USB-A, proprietary connectors, magnetic connectors, or inductive charging interfaces.

In operation, the lighting pod 16 may be powered internally by electrical energy generated by visibly transparent electricity-generating glass within the window assembly, such as photovoltaic or ultraviolet light-converting glass. Electrical power generated by the glass may be routed internally through the window frame or glazing bead to the lighting pod, optionally via an energy storage device. In such embodiments, the power input port may be used for auxiliary charging, diagnostics, or backup power.

Additionally or alternatively, the lighting pod 16 may be powered externally by connecting an external power source to the power input port, such as by plugging a cable into the USB-C connector. The external power source may be used to charge an internal energy storage device, directly power the lighting pod 16, or both. The power input port may be located at any suitable position on or within the window assembly, including on the glazing bead, the window frame, the lighting pod housing, or another accessible portion of the window.

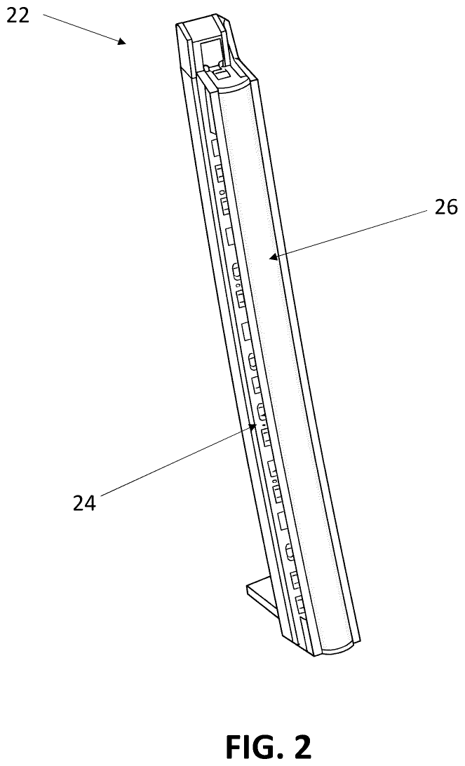

FIG. 2 illustrates an embodiment of a lighting element 22 suitable for use within a window-integrated electronic pod, such as the lighting pod 16 shown and described with respect to FIG. 1B. In the illustrated embodiment, the lighting element 22 comprises an elongated light source in the form of an LED strip 24, although other light sources may be used without departing from the scope of the invention.

In some embodiments, the LED strip 24 includes a plurality of individual point-source light-emitting elements arranged along a longitudinal axis of the strip. The light-emitting elements may be configured to emit light of any desired color temperature or spectral composition. In one non-limiting example, the LED strip is configured to emit warm-colored illumination, suitable for ambient or accent lighting in an interior space. Other embodiments may provide cool white light, tunable white light, colored light, or dynamically adjustable lighting.

As shown, the lighting element 22 is configured for incorporation into a power pod or lighting pod, which may be integrated into a window frame or glazing bead. The lighting element may be electrically coupled to an internal power source, such as an energy storage device charged by visibly transparent electricity-generating glass unit 12, allowing the lighting element to operate without external wiring.

In the illustrated embodiment, the lighting mechanism further includes a diffuser 26 covering or coating positioned over the LED strip 24. The diffuser 26 is configured to optically blend light emitted from the individual point-source LEDs, converting the discrete light points into a substantially uniform, diffuse, and continuous light output as perceived by an observer. The diffuser 26 may comprise a translucent material, an optical coating, a textured surface, or a combination thereof.

In some embodiments, a single point light source, such as an LED, may be mounted at one end of a diffuser tube, thus converting a single light source into a lighting element with a lower energy demand than an LED strip. By converting point-source illumination into a continuous light distribution, the diffuser enhances visual comfort, reduces glare, and improves the aesthetic integration of the lighting element within the window assembly. The combination of a single LED and diffuser enables the lighting pod to provide smooth, even illumination along its length while maintaining a compact form factor suitable for installation within a glazing bead or window frame channel at a low energy budget.

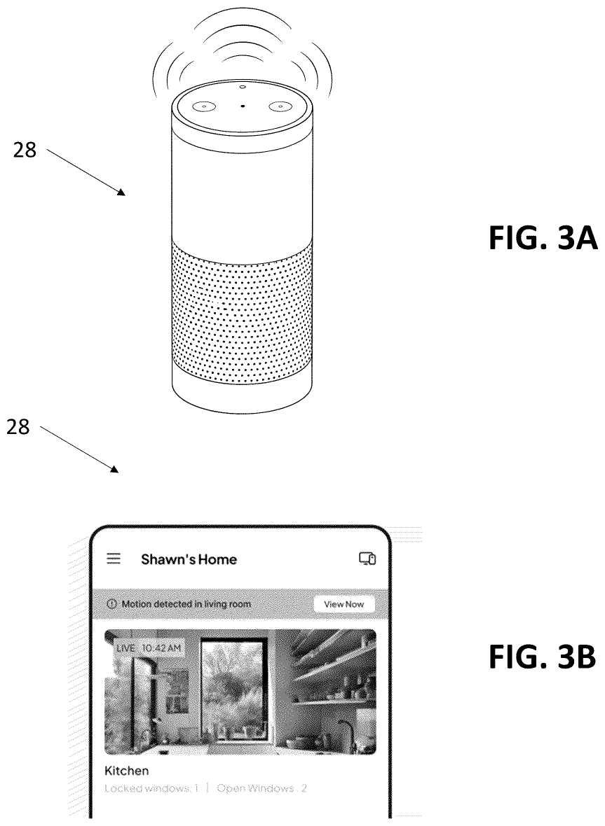

FIGS. 3A and 3B illustrate embodiments of a smart-home control device 28 configured to control operation of one or more window-integrated electronic pods, such as the lighting pods described with respect to FIGS. 1 and 2. In the embodiment illustrated in FIG. 3A, the non-limiting smart-home control device 28 comprises a voice-enabled smart device, although other control interfaces may be used without departing from the scope of the invention. In the embodiment illustrated in FIG. 3B, the non-limiting smart-home control device 28 comprises an app on a smartphone.

The smart-home control device 28 is configured to communicate wirelessly with one or more electronic pods integrated into a window assembly. Such communication may occur using any suitable wireless protocol on any suitable communication module, including but not limited to Matter, Zigbee, Z-Wave, Bluetooth, Wi-Fi, or radio-frequency (RF) communication. Through this wireless communication, the smart-home control device 28 may issue commands to control operation of the window-integrated lighting pod, including turning the lighting on or off, adjusting brightness, changing color temperature, or selecting predefined lighting modes.

In embodiments in which the smart-home control device 28 is voice-enabled, a user may control the lighting pod using spoken voice commands, allowing hands-free operation. In other embodiments, the smart-home control device may include physical buttons, touch-sensitive inputs, or graphical user interfaces presented on a smartphone, tablet, or dedicated controller.

Although not shown in FIG. 3A of FIG. 3B, the smart-home control device may communicate with a centralized home automation system or cloud-based service, enabling integration of the window-integrated lighting pod into broader smart-home routines or automation scenarios. For example, the lighting pod may be automatically activated based on time of day, occupancy, ambient light conditions, security events, or user preferences.

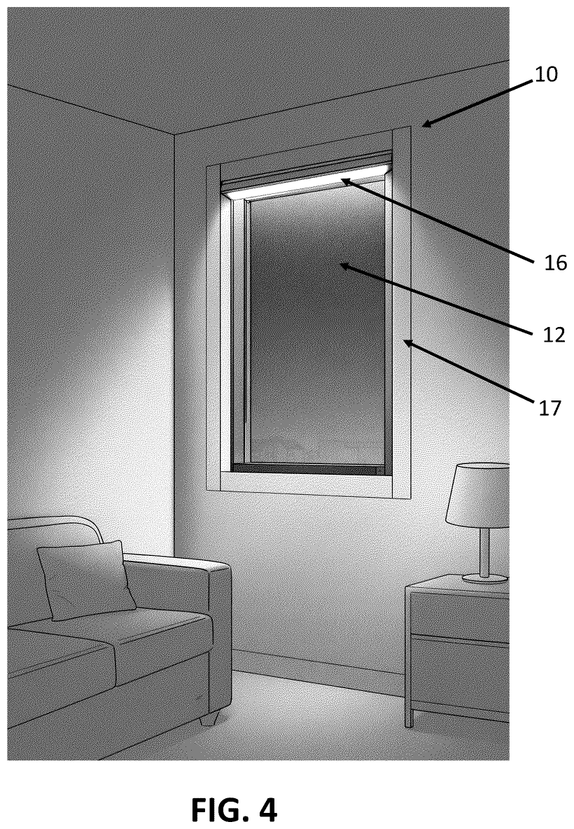

FIG. 4 illustrates an embodiment of a smart window assembly 10 incorporating a window-native lighting pod 16, shown in an interior environment as a rendered visualization. The illustrated embodiment depicts the window assembly 10 installed within an interior space of a building, demonstrating the visual appearance and functional placement of the lighting pod 16 when viewed from inside a room.

As shown, the lighting pod 16 is positioned along an upper interior portion of the window assembly 10, integrated into the window frame 17 as a glazing bead or frame-mounted component. In this embodiment, the lighting pod 16 is configured to emit light downward into the interior space adjacent the window assembly 10, providing illumination that may function as ambient lighting, task lighting, accent lighting, or safety lighting. The placement of the lighting pod 16 within the window frame 17 allows illumination to be provided directly at the window opening without the need for separate wall- or ceiling-mounted fixtures.

In some embodiments, the lighting pod 16 may be installable and repositionable within the window assembly 10. For example, the lighting pod 16 may be removed and reinstalled in an alternative orientation along the bottom of the window frame 17 to provide uplighting, directing illumination toward a ceiling or upper wall surface, or repositioned to another portion of the window frame. This reversibility enables customization of lighting direction and functionality based on user preference or architectural requirements.

Although not visible in FIG. 4, the lighting pod 16 is configured to receive electrical power from visibly transparent electricity-generating glass unit forming at least a portion of the window's glazing. Electrical power may be routed internally within the window assembly and optionally stored in one or more energy storage devices, allowing the lighting pod to operate without external wiring connected to building electrical infrastructure.

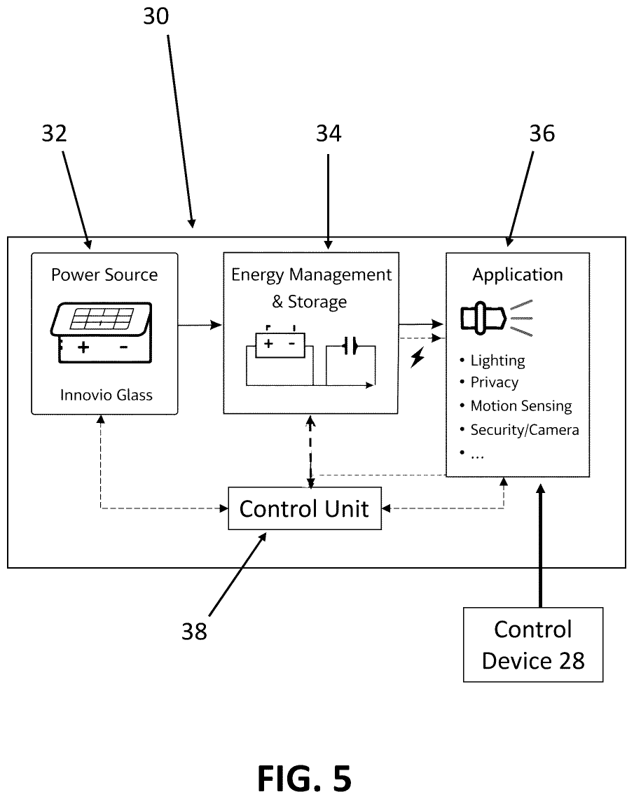

FIG. 5 is a schematic illustration of a power management system 30. The power management system 30 is organized around a structured block architecture that clarifies both functional operation and physical implementation flexibility. As shown in the diagram, the system includes a power source 32 embodied by visibly transparent electricity-generating glass unit 12 (e.g., Innovio glass), an energy management and storage module 34, one or more application modules 36. The power management system 30 may also include an optional coordinated power management control unit 38. The visibly transparent electricity-generating glass unit 12 functions as an integrated energy-harvesting source, converting incident light into electrical energy. This energy is delivered to the energy management and storage block 34, which performs regulation, conditioning, charge control, and storage using elements such as batteries and/or capacitors.

The energy management and storage block 34 may contain a separate energy storage device, or one that is integrated with the energy management and storage block 34. Managed energy is then supplied to application modules 36 that may include lighting, privacy systems, motorized shades, motion sensing, security cameras, removable flashlight elements, or other window-integrated devices.

An optional power management control unit (“brain”) 38 may be incorporated to control the functions energy (e.g., electrical power) harvesting, storage, and deployment to optimize efficiency and operating modes. In some embodiments, the function of optional power management control unit (“brain”) 38 may be distributed throughout the window assembly 10.

Although these functional blocks are conceptually distinct for clarity, their physical implementation may be integrated within the glass unit 12, distributed within the window frame 17, or incorporated into glazing beads. The smart-home control device 28 may be configured to communicate wirelessly with one or more electronic pods integrated into a window assembly 10.

“Energy storage device” typically refers to a component configured to store electrical energy for later use within the window system. Energy storage devices may include, without limitation, rechargeable batteries, supercapacitors, capacitors, or other electrical energy storage technologies. An energy storage device may be located within a pod, within a glazing bead, within a frame element, or elsewhere in the window assembly, and may supply stored energy to one or more window-native components during periods of reduced or absent power generation.

It is surprising that this defined architecture demonstrates that a coordinated, system-level integration beyond conventional window or lighting assemblies to develop a self-contained, wireless window system that integrates lighting “natively” into the window frame, sash, or glazing bead while preserving the primary function of the window as a transparent architectural element capable of providing illumination during both daytime and nighttime conditions is possible. It is also surprising that closed-loop energy harvesting, storage, and deployment within a window-native platform has been produced at such a system-level integration systems. That is, there is no source of power, information, or data that is necessary to be provided from outside of the self-contained, wireless window system for the system to operate in a closed-loop fashion.

The smart-home control device 28 may be configured to communicate wirelessly with one or more electronic pods integrated into a window assembly. As described above, the disclosed window-native lighting system is compatible with existing smart-home ecosystems and control paradigms, allowing window-integrated electronic pods to be controlled in the same manner as other connected devices within a smart home. The illustrated embodiments further highlight that such control may be achieved without physical wiring between the window assembly and external control devices.

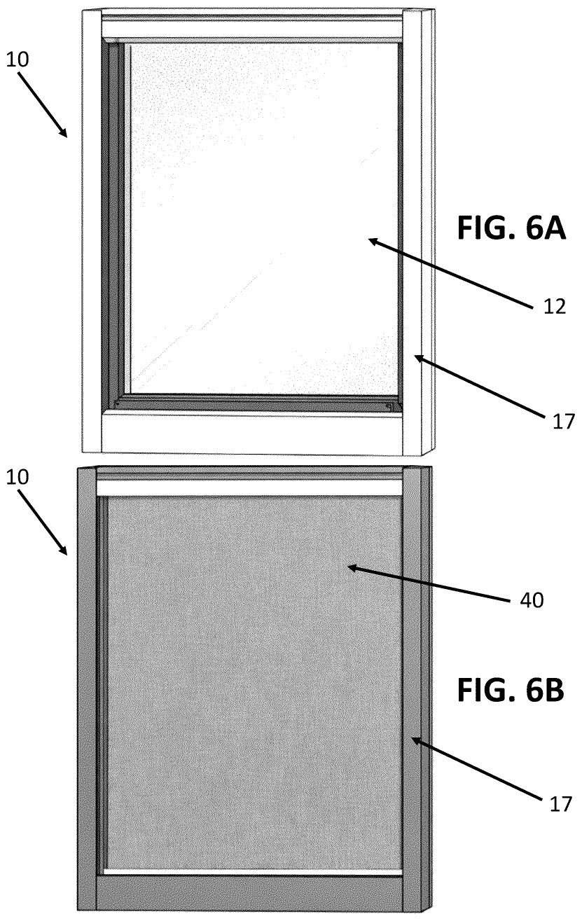

FIGS. 6A and 6B illustrate an embodiment of a fully integrated motorized smart shade system incorporated into a powered window assembly.

FIG. 6A shows a window assembly 10 with motorized smart shade in a raised (open) position, in which the solar-generating glass unit 12 is substantially unobstructed, allowing visible light to pass through the solar-generating glass unit 12.

FIG. 6B shows the motorized smart shade 40 in a lowered (e.g., closed) position, in which the smart shade 40 covers at least a portion of the solar-generating glass unit 12.

In various embodiments, the smart shade 40 is fully integrated within the window assembly 10, such as within the window frame 17, glazing bead region, or an internal cavity adjacent the glazing. The smart shade 40 may be powered by electrical energy generated by visibly transparent electricity-generating glass unit 12 forming part of the window, or, optionally in combination with one or more energy storage devices integrated into the window assembly 10. As a result, the smart shade 40 may operate without external wiring to building electrical infrastructure.

In various embodiments, the shade material used may comprise novel or advanced materials configured to provide blackout conditions when the shade is in the lowered position. In some embodiments, the shade material is further configured to reflect incident sunlight, thereby reducing solar heat gain and improving energy efficiency within the interior space. The reflective and blackout properties may be achieved through multi-layer fabrics, coatings, metallized layers, or other light- and heat-management materials.

Operation of the motorized smart shade 40 may be controlled automatically or manually, including via smart-home control devices 28, mobile applications, voice commands, or programmed schedules. The smart shade 40 may be raised or lowered in response to environmental conditions such as time of day, ambient light levels, temperature, or user preferences.

In various embodiments, additional product configurations may be included in the powered window system 10 that integrates lighting, energy harvesting, energy storage, and motorized shading into a single, self-contained window assembly 10, enhancing occupant comfort, privacy, and energy efficiency while maintaining a clean and integrated architectural appearance.

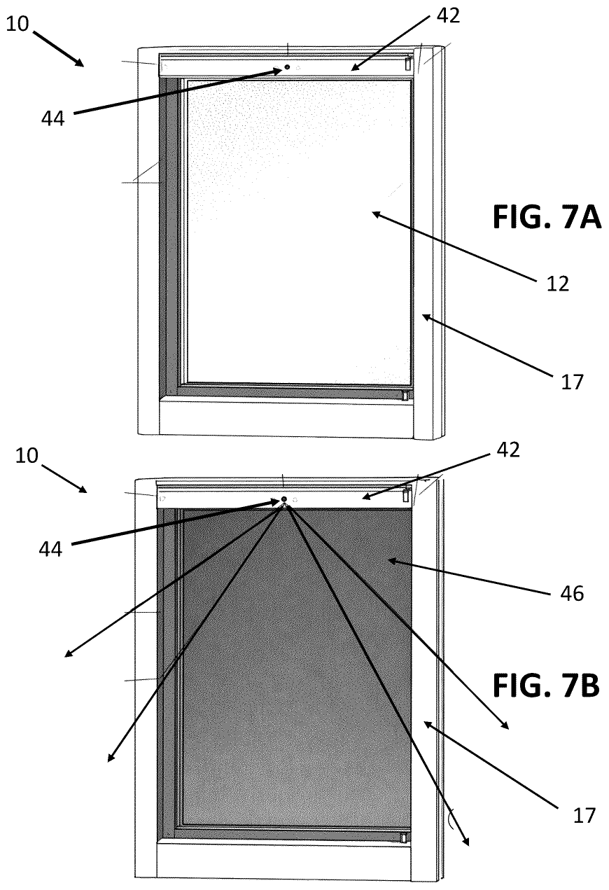

FIGS. 7A and 7B illustrate embodiments of a window-integrated security pod 42 incorporated into a powered window assembly 10. In the various embodiments, the security pod 42 is integrated into the window frame 17 or glazing bead region and is powered by electrical energy generated by visibly transparent electricity-generating glass unit 12 forming at least a portion of the window's glazing.

As shown, the security pod 42 includes one or more embedded security components, which may comprise an imaging device such as a security camera, one or more motion sensors 44, lock and unlock sensors, and associated electronic circuitry. The security pod 42 may be configured to monitor activity at or near the window, detect motion or intrusion attempts, and provide status information regarding window locking or unlocking events.

In various embodiments, the window assembly may further include impact-resistant glass, which may be laminated, tempered, coated, or otherwise reinforced to resist breakage or forced entry. The impact-resistant glass may operate in conjunction with the security pod 42 to provide enhanced physical security while enabling electronic monitoring and detection of security events.

The security pod 42 may be configured to communicate wirelessly with one or more smart-home control devices, mobile applications, or remote monitoring systems, allowing security events to be reported to a user or to a centralized security system. Operation of the security pod 42 may be automated or user-controlled and may be integrated into broader smart-home routines or security protocols.

In some embodiments, the powered window assembly may further include a dynamic tint or smart-glass 46 (e.g., dynamic glass) option applied to the glazing, as shown in FIG. 7B. For example, the dynamic glass 46 may utilize transparent or semi-transparent photovoltaic materials, ultraviolet-converting materials, or combinations thereof, and may be integrated with electrochromic, thermochromic, photochromic, or other functional glass layers. The dynamic glass 46 may be configured to respond to sunlight exposure, ambient light levels, temperature, or user commands to adjust optical properties such as transparency or tint. By dynamically controlling light transmission, the dynamic glass 46 can improve energy efficiency, thermal comfort, glare reduction, and privacy within an interior space.

Electrical power for the security pod 42, dynamic glass 46, and associated sensors may be generated by the visibly transparent electricity-generating glass and optionally stored in one or more energy storage devices integrated into the window assembly. As a result, the security and dynamic tint functionalities may operate without external wiring, facilitating installation in both new construction and retrofit applications within existing homes and buildings.

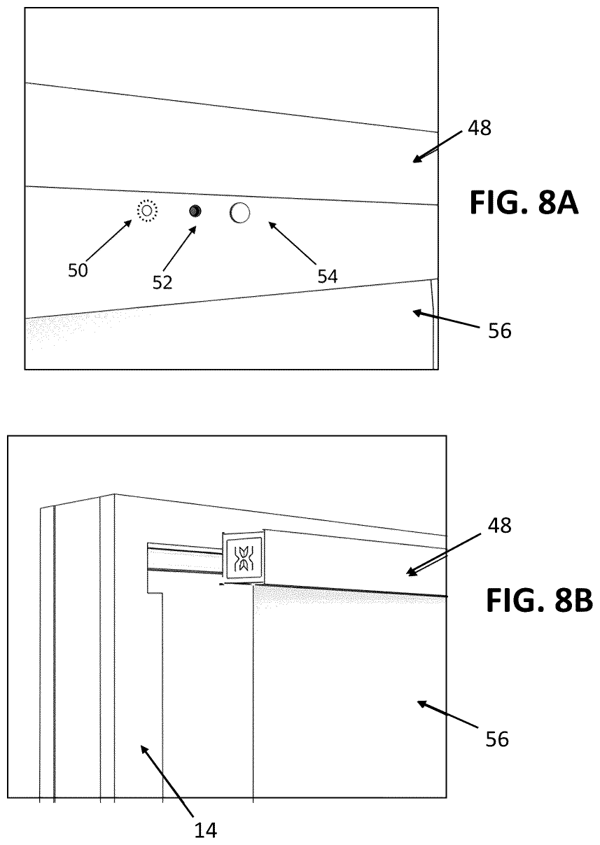

FIGS. 8A and 8B illustrate expanded and detailed views of an embodiment of a combined security-privacy pod 48 integrated within a window assembly. In FIG. 8A, a portion of the combined security-privacy pod 48 is shown enlarged to reveal internal and external functional components. Specifically, the embodiment includes a speaker 50 configured to emit audible alerts, communication signals, or voice responses; a camera 52 positioned to monitor an interior fields of view; and a proximity sensor 54 configured to detect motion, presence, or user interaction within a predetermined sensing range. These components may be operatively connected to an internal power management and storage system and may be controlled locally or remotely. The proximity sensor 54 may be configured to activate or wake the camera 52 and/or speaker 50 from a low-power state in response to detected motion, thereby conserving energy. A privacy shade 56 is shown extending downward from the combined security-privacy pod 48, illustrating how the pod may integrate both sensing/security functionality and privacy control within a single modular unit.

FIG. 8B illustrates an embodiment of the combined security-privacy pod 48 installed within a glazing bead 14 of a window frame. In this embodiment, the glazing bead 14 is specifically configured to receive and support the combined security-privacy pod 48, allowing the pod to be inserted, removed, or replaced without structural modification to the window assembly. The glazing bead 14 may include mechanical retention features, electrical interfaces, or alignment structures to ensure proper mounting and connectivity. The privacy shade 56 is again shown extending below the combined security-privacy pod 48, demonstrating how the integrated pod can house or control deployment of the shade while simultaneously supporting security functions such as video monitoring and proximity detection. This configuration illustrates a modular, window-native approach in which security and privacy features are consolidated within the glazing bead region, enabling streamlined installation, reduced wiring complexity, and enhanced functional integration within the window system.

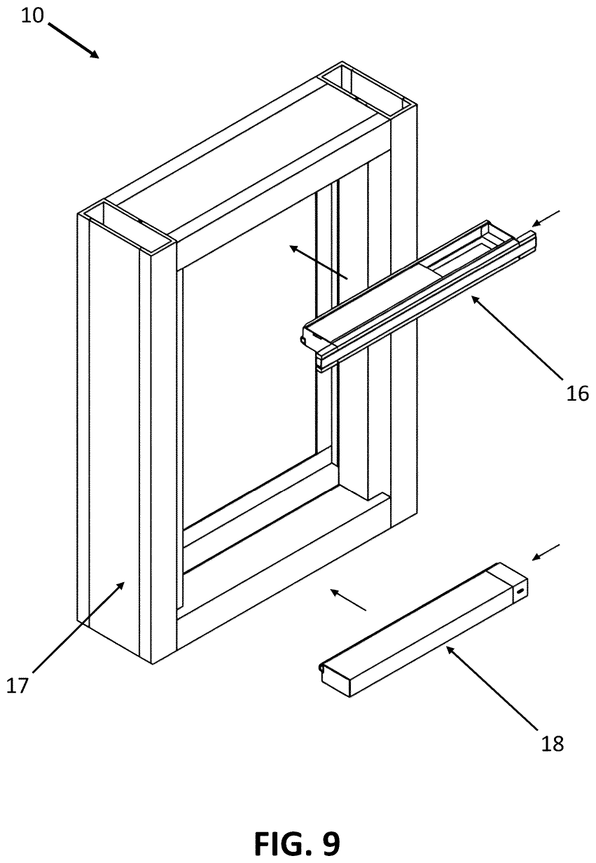

FIG. 9 illustrates an embodiment of a smart window assembly 10 incorporating modular, insertable components configured to provide lighting functionality and related electronic features. As shown, the window frame is adapted to receive an insertable lighting component 16 (e.g., lighting pod) positioned along an upper portion of the frame 17. The insertable component may include lighting elements such as Light Emitting Diodes (LEDs), optical diffusers, light guides, and associated supporting electronics. The component may further house energy storage elements, including batteries or capacitors, which are electrically coupled to the window's internal power generation system. This modular insert is configured for easy installation into the window frame and may be removed for maintenance, replacement, or upgrade without disturbing the structural integrity of the window assembly.

FIG. 9 further shows a top lighting pod 16 composed of inner and outer pieces that may be fit together. This configuration allows the lighting pod 16 to be installable and removable, and able to disassembled for servicing or component replacement while maintaining a secure fit during operation. Also depicted is an installable and removable electronic pod 18 (e.g., charging pod) configured to function as a glazing bead. This glazing bead-mounted electronic pod may include a USB-C access port, power conversion circuitry, and a rechargeable battery, and may be used to recharge a system battery when required. The glazing bead design permits the electronic pod to be inserted and removed in a manner consistent with conventional window installation practices, thereby enabling simplified assembly, modularity, and serviceability within the smart window platform.

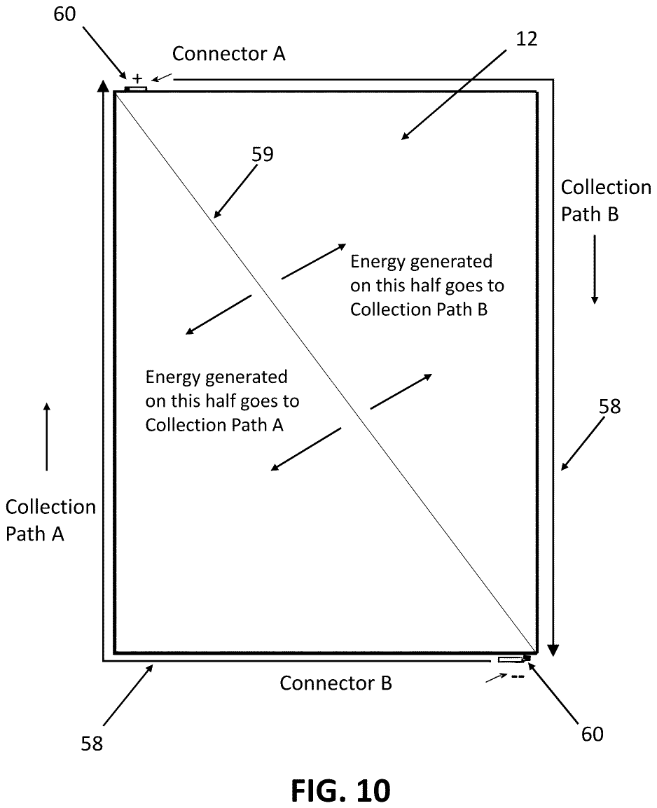

FIG. 10 illustrates an embodiment of an insulated glass unit (IGU) configured as a visibly transparent electricity-generating glass unit 12 incorporating an edge treatment. The edge treatment is typically made up of series-connected solar cells along the edge of the laminated glass that collects light that is wave-guided to the edge treatment and converts this light into electrical energy. This electrical energy is made available at one or more connectors 60 somewhere on the edge of the laminated glass or the IGU, typically in the corners, but not necessarily. The connector could be located anywhere along any of the glass edges, included but not limited to the middle of an edge, by attaching wiring to the provided connector(s). This collected and converted energy is routed to the energy management and storage block, by which it is then stored for use by an application. The edge treatment is the primary collection method. The system routes the light energy converted to electrical energy from the connector.

As shown, electronic leads 60 forming positive (+) and negative (−) terminals extend from the edge treatment disposed along one or more peripheral edges of the IGU. The IGU itself comprises a transparent electricity-generating glazing structure, such as a photovoltaic layer or luminescent solar concentrator integrated within the glass stack.

In the embodiment illustrated in FIG. 10, the energy pickup is split into two separate power sources from the same window since the power generation and collection structures are divided by the diagonal line 59. But, this is only one example. In some embodiments, the entire window could be the power source for a single circumferential energy conversion circuit. The two collection path arrows wrap around the corners of the glass to indicate two separate, diagonally split pickup points creating two separate charging paths, one for the lower path, and one for the upper path.

The transparent electricity-generating glazing structure generates charge carriers that are collected along Collection Path A and Collection Path B and transported to Connector A and Connector B, respectively. The internal wiring may be embedded within or adjacent to a spacer region, sealant region, or edge channel of the IGU, thereby preserving optical transparency across the primary viewing area while enabling electrical extraction from the energy-generating glass.

FIG. 10 further illustrates that internal power circuitry may be configured to distribute harvested energy along the edges of the IGU for delivery to various portions of the window assembly 10. In the depicted embodiment, power routed along the perimeter of the glass may supply a charging port or interface located at the bottom of the window frame 17. From this charging interface, electrical energy may be provided to lighting fixtures or other electronic components positioned in another section of the window system, such as a lighting pod located at the top of the frame. This edge-based power routing architecture allows the IGU to function as an integrated energy source while maintaining concealed wiring paths and modular connection points. The illustrated configuration demonstrates how electronic leads (+ and − terminals) extracted from internal IGU wiring enable distributed power delivery within the window frame without requiring external wiring or penetration through surrounding building structures.

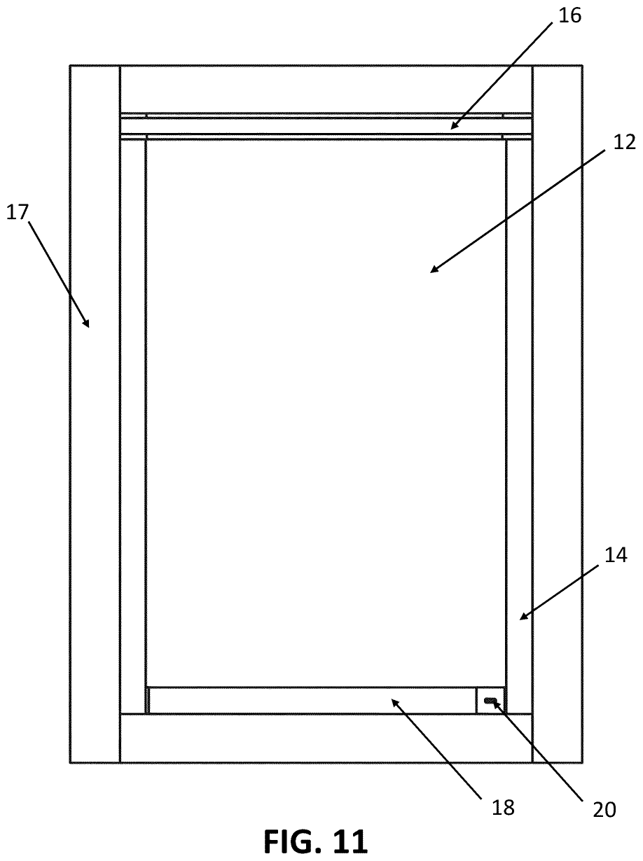

FIG. 11 illustrates a face-on view of an integrated window system 10 in its fully assembled configuration. As shown, the window frame 17 surrounds solar-generating glass 12, with glazing beads 14 installed around the perimeter to secure the glass 12 within the frame 17. In this embodiment, the glazing beads 14 incorporate modular electronic pods positioned at distinct locations within the frame structure. A lighting pod 16 is integrated into the upper glazing bead region, while a charging pod 18 is integrated into the lower glazing bead region. The lighting pod 16 at the top of the frame may house illumination elements such as LEDs and optical components, whereas the charging pod 18 at the bottom may include a power interface 20, such as a charging port or electrical connection point, configured to receive or distribute electrical energy within the window system.

The face-on perspective demonstrates how the lighting pod and charging pod are visually integrated into the window assembly without altering the conventional appearance of the window. The glazing beads remain structurally consistent with traditional window components while accommodating embedded electronics. The vertical arrows shown in the figure indicate the functional relationship between the upper and lower regions of the window system, illustrating that electrical power generated or routed within the frame may be transferred from the charging pod at the bottom to the lighting pod at the top. This configuration highlights the modular and distributed nature of the integrated window system, in which distinct functional elements—such as lighting and charging—are incorporated into different portions of the glazing bead structure while maintaining a cohesive, assembled unit.

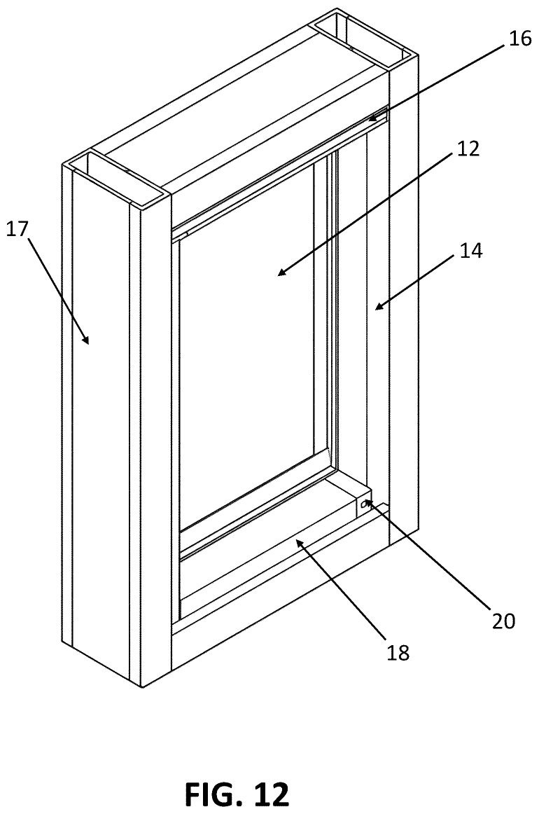

FIG. 12 illustrates a three-quarter view of an integrated window system 10 in its fully assembled configuration. The figure depicts the window frame 17 in cross-sectional profile, showing the relative positioning of structural components and integrated electronic elements. Glazing beads 14 are shown installed along the interior-facing portions of the frame 17, securing the solar-generating glass 12 within the frame assembly. Positioned at the upper glazing bead location is a lighting pod 16, while a charging pod 18 is positioned along the lower glazing bead. These pods are integrated into the glazing bead structure so that they align with the frame geometry while maintaining the conventional structural appearance of a standard window assembly.

The solar-generating glass 12 is shown seated behind the glazing beads 14 and within the frame cavity. The solar-generating glass 12 may comprise a visibly transparent electricity-generating glass layer and associated spacer or seal structures. The side view illustrates how the lighting pod 16 at the top and the charging pod 18 at the bottom may be mechanically supported by and electrically coupled through the glazing bead regions. In this embodiment, electrical energy may be routed between the charging pod 18 and the lighting pod 16 through internal wiring concealed within the frame or glazing bead channels. The configuration demonstrates the modular, layered construction of the integrated window system 10, highlighting the spatial relationship between the structural frame 17, the glazing beads 14, the solar-generating glass 12, and the integrated electronic pods while preserving a compact and serviceable assembly.

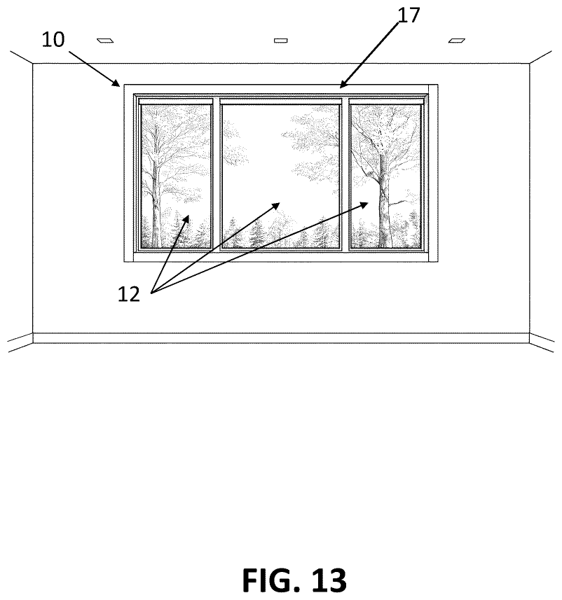

FIG. 13 illustrates another embodiment of a self-contained, wireless window system 10 installed within an architectural wall structure. In this embodiment, the window assembly 10 includes three solar-generating glass units 12 mounted side-by-side within a common frame structure. Each solar-generating glass unit 12 may comprise a transparent or semi-transparent photovoltaic glazing layer integrated within an insulated glass unit (IGU), configured to harvest incident light energy while maintaining visual transparency. The solar-generating glass unit 12 are retained within surrounding frame members 17 that define the perimeter of the window opening and provide structural support, weather sealing, and integration with adjacent wall construction. The illustrated embodiment demonstrates a multi-panel configuration in which each individual solar-generating glass unit 12 is an independent power source and that has it's own energy storage device.

In various embodiments, the number, arrangement, and dimensions of the mounted solar-generating glass units 12 may be selected based on architectural requirements, aesthetic preferences, structural constraints, or energy-generation targets. For example, the panels may be configured as fixed panes, sliding panels, casement windows, or other operable forms, and may vary in width, height, or thickness according to building codes or design objectives. The modular nature of the solar-generating glass units 12 allows the window assembly 10 to be scaled or customized for residential, commercial, or retrofit applications while maintaining the self-contained, wireless functionality of the integrated system.

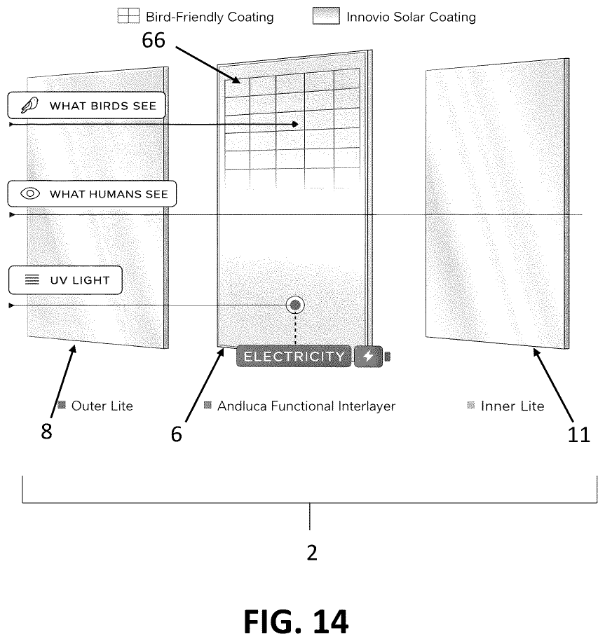

FIG. 14 illustrates a schematic representation of an embodiment of solar-generating glass units 12 (e.g., Innovio glass) incorporating multiple functional coatings and interlayers within the laminated glass 2. As shown, the IGU (e.g., glazing assembly) includes an outer layer 8 (e.g., lite) and an inner layer 11 (e.g., lite) separated by solar energy-generating functional interlayer 6 that may include an LSC solar coating and, in some embodiments, a bird-friendly coating 66. The bird-friendly coating 66 is depicted as a patterned grid visible in the ultraviolet spectrum, representing what birds see when approaching the glass. In contrast, the schematic also illustrates “what humans see,” indicating that the coating remains substantially invisible to the human eye under normal visible-light conditions. The solar energy generating coating is configured to absorb ultraviolet (UV) light, as indicated by the UV light pathway shown in the figure, and convert that energy into electrical power. The converted energy is then routed for storage, as schematically represented by the electricity icon and battery symbol.

In various embodiments, the advanced coating materials within the functional interlayer 6 absorb and convert ultraviolet light into electrical energy while maintaining high optical transparency. The harvested energy may be stored within the window frame 17 and used to power integrated smart window functions, such as lighting, dynamic tinting, sensors, communication modules, and other wireless electronic components, without requiring external wiring. In addition to energy harvesting, the coating system may improve impact resistance, dampen sound transmission, and block harmful UV radiation from entering interior spaces. The bird-friendly coating 66, certified as “Bird-Friendly” glass by the American Bird Conservancy, provides visual cues in the UV spectrum that deter birds and reduce collision events while remaining minimally perceptible to human occupants. Despite the integrated smart functionality, the window assembly is designed to install like a standard window and maintains less than approximately a one percent difference in visible light transmission compared to conventional glazing. While residential applications may serve as an initial market focus, the underlying chemistry and coating technologies enable expansion into adjacent architectural and commercial markets.

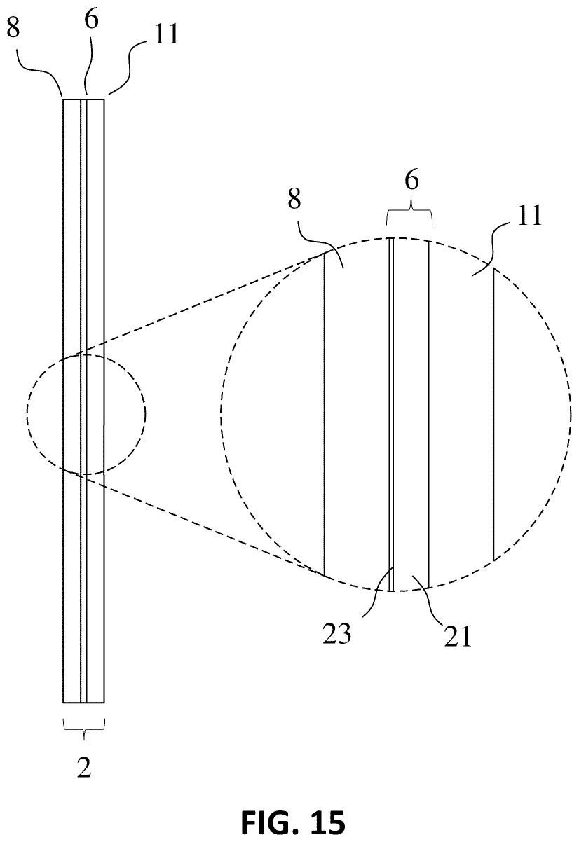

FIG. 15 schematically illustrates an embodiment of a laminated glass 2 assembled with an interlayer 6 positioned between an outside layer 8 and an inside layer 11. The interlayer 6 includes two ultraviolet (UV) materials, a first UV material 21 and a second UV material 23, which may be supported on a clear, flexible substrate. In certain embodiments, the first and second UV materials are configured to absorb radiation at different wavelength ranges. The first UV material 21 may be thicker than the second UV material 23, and one or both UV materials may have variable thicknesses to tailor UV transmission characteristics. In some embodiments, the UV absorption properties may be adjusted by controlling material thickness and intrinsic absorbance in accordance with Beer-Lambert principles to achieve a desired level of UV transparency or attenuation.

The bird-friendly interlayer 66 may comprise a film of a UV absorbing material deposited, grown, applied, printed, gravure printed, offset printed, spun, evaporated, sputtered, cast, or the like, on a clear, flexible substrate, such as a polymer film. The clear, flexible substrate may have a transparency greater than 95% over the visible wavelength ranges, a transparency greater than 90% over the visible wavelength ranges, a transparency greater than 90% over the visible wavelength ranges, or a transparency greater than 85% over the visible wavelength ranges, whereas the UV frequency ranges are blocked by the UV absorbing material.

In certain embodiments, the first UV material 21 may be extruded onto and adhered to the flexible substrate to form the interlayer 6, while the second UV material 23 may be patterned as a coating on the first UV material 21. The patterned second UV material 23 may provide contrast in the UVA range to enhance bird visibility while maintaining high visible-light transparency for human occupants. The interlayer 6 may be adhered to inner surfaces of the outside layer 8 and the inside layer 11 to form the laminated structure. The UV materials may be applied using roll coating, web printing, gravure printing, sputtering, casting, or similar deposition techniques to achieve uniform thickness and strong adhesion. The flexible substrate may comprise a polymer film exhibiting high transparency across visible ranges, and the laminated glass assembly may include rigid or flexible glass materials, including thin, bendable glass substrates capable of maintaining optical quality and structural integrity under bending conditions.

The laminate 2 may further include one or more layers of dynamic glass. The one or more layers of dynamic glass may include an electrochromic (EC) layer. The EC layer may be electrically dimmable. The EC layer may be electrically tintable. The electrical control of the EC layer allows for remote control of the dimming and tinting of the smart window assembly 10.

### Transparent Luminescent Solar Concentrators (LSCs)

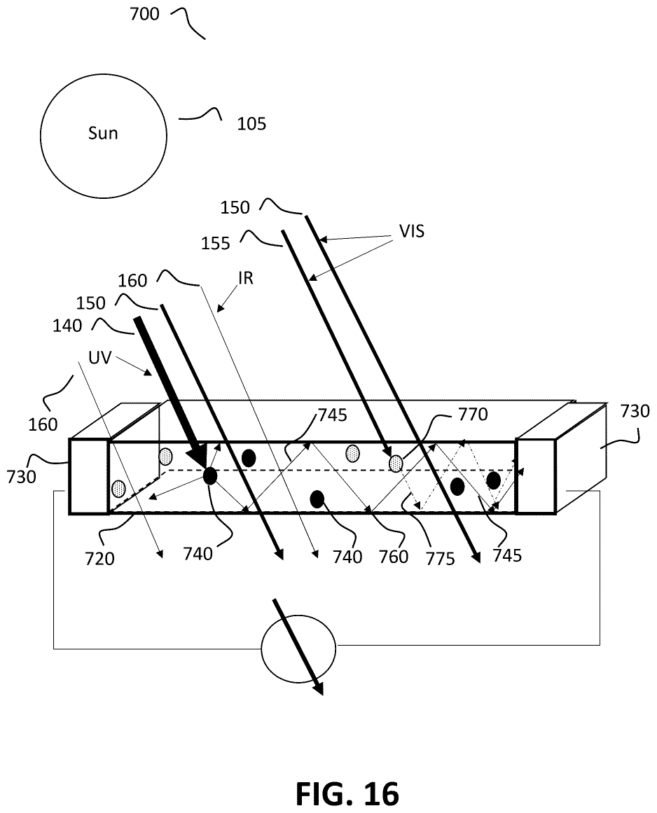

In various embodiments, the IGU may include luminescent solar concentrators (LSCs) which may be transparent or semi-transparent to visible light. FIG. 16 schematically shows an embodiment of a transparent luminescent solar concentrator (e.g., LSC) 700. This embodiment of a transparent LSC 700 includes a film, plexiglass, or glass substrate 720 that can act as a waveguide for absorbed radiation. The radiation may be concentrated as re-emitted light in plane, and/or harvested at a periphery (e.g., side surface, or edge) of the film, plexiglass, or glass substrate, for electricity.

A photovoltaic device 730 is positioned at a side edge of the of the LSC substrate 720 to collect radiation that is emitted from the substrate waveguide 720. The photovoltaic device 730 may be comprised of any type device that converts radiation into electrical power. Examples include, but are not limited to, thin film, single crystal, polycrystalline, amorphous photovoltaic devices, and the like. The solar materials may include, but are not limited to, silicon, CdTe (cadmium telluride), GaAs (gallium arsenide), CGIS (copper gallium indium sulfide), transparent OPV's, and the like.

In illustrative embodiments, one or more embedded luminophores that absorb and emit light during device operation may be embedded in the substrate. The embedded luminophore(s) may be, but is not limited to, one or a combination of two of more of the following: coumarins, naphthalimides, coronenes, anthracenes, rubrenes, thiophenes, fluorenes, diazafluorenes, fluorenones, dicyanomethylenes, rhodamines, perylenebisimides, and bipyridines, as the UV absorbing luminophore(s) 740 (absorbing near UV light with a peak absorption between 300 and 450 nm), which may emit photons 745 at a different wavelength than was absorbed (emitting in the visible with peak wavelengths from 400 to 780 nm). The photons 745 emitted from the UV absorbing luminophore 740 may be internally reflected 760 off of the surfaces the LSC substrate 720 and directed to the photovoltaic device 730 for conversion to electrical power.

In illustrative embodiments, embedded luminophores may be visible light absorbing luminophores 770 that absorb a narrow wavelength band of visible light. The embedded luminophore(s) may be, but is not limited to, one or a combination of two of more of the following: coumarins, naphthalimides, coronenes, anthracenes, rubrenes, thiophenes, fluorenes, diazafluorenes, fluorenones, dicyanomethylenes, rhodamines, perylenebisimides, and bipyridines. For example, an embedded luminophore may be a VIS absorbing luminophore 770 (absorbing visible light with a peak absorption between 400 and 780 nm), which may emit photons 775 at a different wavelength than was absorbed (emitting in the visible and near infrared with peak wavelengths from 400 to 1000 nm). The photons 775 emitted from the VIS absorbing luminophore 770 may be internally reflected off of the surfaces the LSC substrate 720 and directed to the photovoltaic device 730 for conversion to electrical power. The luminophores that are incorporated into LSC devices may also be used as a patterned base layer, as well as a patterned second layer.

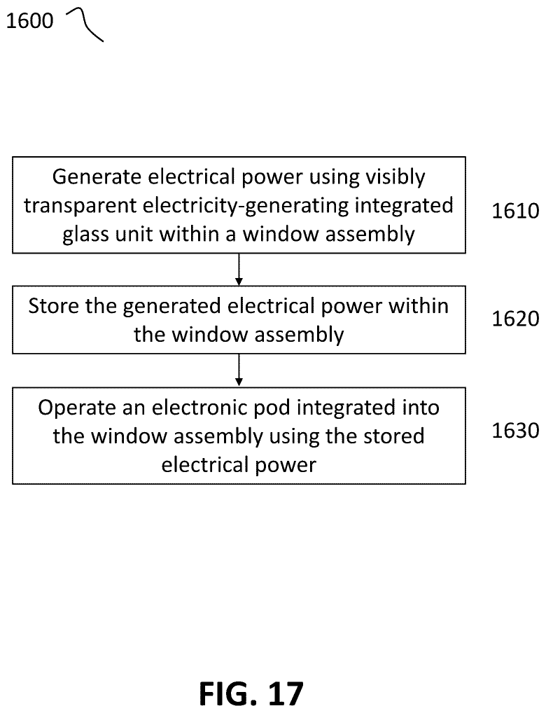

FIG. 17 shows an embodiment of a method of powering one or more window-integrated functions. In Step 1610, electrical power is generated using visibly transparent electricity-generating integrated glass unit (IGU) within a window assembly. The visibly transparent electricity-generating glass generates electrical energy from incident light while permitting at least partial transmission of visible light through the glass. Such glass may incorporate photovoltaic materials, ultraviolet-converting materials, or other light-to-electricity conversion technologies, and may be transparent, semi-transparent, or selectively transmissive. The electricity-generating functionality may be provided by coatings, films, laminated layers, embedded devices, or combinations thereof, and may be integrated into one or more panes of an insulated glass unit.

In Step 1620, the generated electrical power is stored within the window assembly. The generated electrical energy is delivered to an energy management and storage module that performs voltage regulation, charge control, conditioning, and storage in one or more energy storage elements (e.g., batteries or capacitors). The energy management and control module may store excess energy that is not being used by the various electronic pods in energy storage devices, which refer to a component configured to store electrical energy for later use within the window system. Energy storage devices may include, without limitation, rechargeable batteries, supercapacitors, capacitors, or other electrical energy storage technologies. An energy storage device may be located within a pod, within a glazing bead, within a frame element, or elsewhere in the window assembly, and may supply stored energy to one or more window-native components during periods of reduced or absent power generation. Stored energy is then supplied to one or more application modules, which may include lighting, motorized shading, privacy systems, motion sensing, security cameras, or other window-integrated functions. An optional power management control unit (“brain”) coordinates energy harvesting, storage, and distribution based on operating conditions and system demands.

In Step 1630, an electronic pod integrated into the window assembly is operated using the stored electrical power. The stored power supports a wide range of window-integrated functions, including lighting, security, privacy, shading, sensing, and smart-home connectivity while preserving the appearance, simplicity, and installability of a conventional window. The combination of self-generated power, internal energy storage, and interchangeable pods enables a flexible, future-proof window platform capable of evolving alongside emerging smart-home technologies.

The features and elements described herein may be combined in any technically feasible manner. Unless expressly stated otherwise, embodiments including fewer than all of the features of a particular example are contemplated. Individual features disclosed in connection with a given embodiment may be combined with, replaced by, or omitted in view of features of other embodiments, even if such modifications are not explicitly illustrated or described. Certain features described herein may be optional, and embodiments lacking one or more such features are also contemplated. Various embodiments may be understood as addressing a technical problem and/or producing a technical effect.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A powered window system, comprising:
a window assembly comprising a frame and an integrated glass unit (IGU);
visibly transparent electricity-generating glass forming at least a portion of the IGU;
at least one energy storage device electrically coupled to the visibly transparent electricity-generating glass;
at least one electronic pod integrated into the window assembly; and
a power management system, wherein:
the at least one electronic pod is configured to receive electrical power generated by the visibly transparent electricity-generating glass and to operate without external wiring to the window assembly; and
the power management system controls energy harvesting, storage, and deployment to optimize efficiency and operating modes.

2. The powered window system of claim 1, wherein the at least one electronic pod is integrated into a glazing bead or frame channel of the window assembly.

3. The powered window system of claim 1, wherein the at least one electronic pod comprises a lighting element.

4. The powered window system of claim 1, wherein electrical power is routed internally within the window assembly from the visibly transparent electricity-generating glass to the at least one electronic pod.

5. The powered window system of claim 1, wherein the at least one electronic pod is installable and removable from the window assembly.

6. The powered window system of claim 1, wherein the energy storage device is located within the at least one electronic pod.

7. The powered window system of claim 1, wherein the energy storage device is located within a glazing bead or frame element of the window assembly.

8. The powered window system of claim 3, wherein the lighting element comprises one or more light-emitting diodes and a diffuser.

9. The powered window system of claim 3, wherein the lighting element is configured to provide ambient lighting, task lighting, safety lighting, or accent lighting.

10. The powered window system of claim 1, wherein the at least one electronic pod is configured to communicate wirelessly using a smart-home protocol.

11. The powered window system of claim 10, wherein the smart-home protocol comprises Matter, Zigbee, Z-Wave, Bluetooth, Wi-Fi, or RF communication.

12. The powered window system of claim 1, wherein the visibly transparent electricity-generating glass comprises transparent photovoltaic material, ultraviolet light-converting material, or luminescent solar concentrator material.

13. A modular electronic pod for installation in a window assembly, comprising:
a housing dimensioned to fit within a glazing bead or frame channel of a window;
at least one electronic component; and
an electrical interface configured to receive power from visibly transparent electricity-generating glass within the window assembly,
wherein the pod is installable and removable within the window assembly.

14. The modular electronic pod of claim 13, wherein the electronic component comprises a lighting element.

15. The modular electronic pod of claim 13, wherein the electronic component comprises at least one of a sensor, camera, motor, or communication module.

16. The modular electronic pod of claim 13, further comprising an energy storage device.

17. The modular electronic pod of claim 13, wherein the pod is installable from an interior side of the window assembly.

18. A method of powering window-integrated functions, comprising:
generating electrical power using visibly transparent electricity-generating integrated glass within a window assembly;
storing the generated electrical power within the window assembly; and
operating an electronic pod integrated into the window assembly using the stored electrical power,
wherein the electronic pod operates without external wiring to the window.

19. The method of claim 18, wherein operating the electronic pod comprises illuminating an interior space.

20. The method of claim 18, wherein the electronic pod is installed or replaced without removing the window assembly.

21. A window assembly, comprising:
an insulated glass unit (IGU) including visibly transparent electricity-generating glass;
internal electrical conductors extending along an edge of the insulated glass unit; and
one or more window-integrated functions integrated into the window assembly, wherein:
the one or more window-integrated functions is powered by electrical power generated by the IGU; and
the electrical power is conducted to the one or more window-integrated functions via the internal electrical conductors.

22. The window assembly of claim 21, further comprising:
a frame, the frame configured to secure the IGU;
at least one electronic pod integrated into the window assembly, the one or more window-integrated functions being positioned in the at least one electronic pod; and
a power management system, wherein:
the electronic pod is configured to receive electrical power generated by the visibly transparent electricity-generating glass and to operate without external wiring to the window assembly; and
the power management system controls energy harvesting, storage, and deployment to optimize efficiency and operating modes.
